(19) United States
(12) Patent Application Publication
(10) Pub. No.: US 2003/0055728 A1
(43) Pub. Date: Mar. 20, 2003

(54) Distributed open customer relationship management and care (CRMC) programs implemented with on line vouchers

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 10/245,452

(22) Filed: Sep. 17, 2002

Related U.S. Application Data
(60) Provisional application No. 60/322,961, filed on Sep. 18, 2001.

(51) Int. Cl. G06F 17/60

(52) U.S. Cl. 705/14

(57) ABSTRACT

The present invention is a method for transferring electronic vouchers over a network system for defining and rewarding a customer relationship management and care (CRMC) activity. In a preferred embodiment, the method further includes a step of transferring an incentive electronic voucher for payment of an assessment of customer satisfaction.

This is a Formal Application claims the Priority date of a Provisional Application No. 60/322,961 filed on Sep. 18, 2001. The Provisional Application No. 60/322,961 is a Continuous-In-Part (CIP) Application of a previously filed co-pending Application with Serial No. 60/203,154, filed on May 9, 2000 and Ser. No. 09/851,793 filed on May 8, 2001 by identical sole inventor as for this Continuation-in-Part (CIP) Application.

### BACKGROUND OF THE INVENTION

1. Field of the Invention

This invention relates generally to method and apparatus for providing methods and systems for carrying out customer relationship management (CRM) programs. More particularly, this invention is related to methods and apparatus to effectuate distributed and open customer relationship management programs by employing voucher systems aided by service-quality incentive vouchers controlled by customer to reward and enhance quality services in carrying out the customer relationship management and caring (CRMC) programs.

2. Description of the Related Art

The tasks required to achieve excellence in handling the customer relationship management (CRM) are rapidly becoming more burdensome and challenging for all good and service providers, particularly those online good and service providers (GSP). This is particularly true as ever-increasing activities of electronic commerce (e-commerce) are carried out online, and meanwhile the goods and services that offered for sales online and “off-line” involve application of higher level of technologies and many operational options. A customer intends to buy a computer or digital camera are faced with a decision that requires technical and product researches. When there are so many types and options offered for sales made by different manufacturers and listed at different prices by different online good and service providers, it is often beyond customers' capabilities to make intelligent decision without some consultation from experts or experienced buyers in the relevant fields. Even with the help of Consumer Reports and information provided by online databases, customers' individual needs and special considerations cannot be satisfied with these passive information sources. Without the help of product consultants or and advice from experienced owners of related products, including direct and interactive discussions, a customer seeking and searching to purchase goods and services online often experience confusions and frustration when faced with overwhelmed amount of data and information. These difficulties will become even more widespread and more pronounced. As the manufacturing and operations of these products now involve higher levels of technologies, thus proportionally, customers would require more help to make intelligent decision in purchasing a product suitable for satisfying individual and special needs.

Conventional methods of providing product information are generally carried out through advertisements or information displayed on Web-sites. However, these centralized seller-initiated methods of information transfer may not answer customer specific questions related to the products. Larger corporations setup customer calling-center to respond to customers' inquiries. Improvements in efficiency to respond to customers; needs are focus of attention now under review by many experts in this field. Efforts includes the improvements of the telephone system to reduce customers' on-hold time and providing designated customer relationship representatives to handle questions from important customers are implemented to resolve some of the difficulties now faced by the industries. However, as the demands for individual cares and answers to specific questions are increased, calling center, even with large number of staffs are not sufficient to effectively and timely handle customers' questions. Furthermore, a customer may want to gather and compare data and information from many different manufacturers for making an intelligent decision. Calling centers, even if effectively operated by different companies, cannot directly help a customer to reduce the times and efforts required to carry out the product research before a decision can be made for finding a product that would satisfy customer's individual and special needs. The limitations imposed by a centralized customer care program cannot resolve the difficulties that relevant customer-specific produce information, personal experiences in using the product and objective product evaluations cannot effectively provided to a customer.

With these limitations, customer's specific individual needs are not properly cared even large amounts of moneys and resources are devoted by manufacturers and sellers of products or services in attempt to satisfy customers' needs. The limitations and difficulties arise form the fact that these efforts and methods provided by manufacturers and sellers of goods or services are based on a centralized configuration by implementing single source information channel, i.e., the information channel provided by the seller or manufacturer. Due to the fact that customer's individual and special needs are not specifically considered or taken care of under current models of customer relationship management (CRM) programs setup by manufacturers and sellers by implementing the centralized single-source information channels. These information channels may include advertisements, Web-sites, or customer calling centers and these information channels are all established more from manufacturer or seller's perspectives. Due to these limitations, large amount of moneys and organizational efforts are unnecessarily wasted without a direct correlation to customer satisfaction resulted from such programs.

Therefore, a need exists in the art of electronic commerce to provide apparatuses and methods by making use of the available network communication and database accessibility capability to openly distribute the customer relationship management programs. On the one-hand it is desirable for a seller to have better cost basis directly related to services performed for customer relationship management program correlated to actual sales realized. On the other hand, it is also desirable to enable a customer to work with a customer relationship management service providers to receive specific consultations specifically address individual customer needs and is enabled to reward the CRM service provider according to a level customer satisfaction.

It is also desirable that the good-or-service provider (GSP) customers are provided with incentive vouchers to reward a CRM service provider for different levels of service quality. Particularly, if a CRM service provider consistently receives awards from different customers, an online good and service provider (GSP) can reward the CRM service with rewards in addition to the awards received from customers. The voucher system thus provides an economic and efficient system with direct correlation between CRM service and sales.

### SUMMARY OF THE PRESENT INVENTION

It is therefore an object of the present invention to provide new and improved systems and methods to facilitate an open and distributed customer relationship management and caring (CRMC) program with vouchers to clearly track the processes and transactions between a potential buyer, a seller, and a service provider. The purpose is to manage the CRMC program with a built-in incentive to reward services performed by the service provider with high quality without requiring the sellers of goods and services to spend additional time and energy to maintain the CRMC programs. The cost incurred in each step of the processes can be more definitely quantified, and the entire process can be tracked with a specified tracking system, such that the difficulties and limitations for customer relationship management (CRM) service commonly encountered in transactions conducted with conventional electronic commerce can be resolved.

Specifically, it is an object of the present invention to provide systems and methods to enable a seller to provide options for a buyer or potential buyer to select different levels of customer service management and caring (CRMC) programs. The selection options may include an option to purchase different CRMC vouchers for different CRMC programs with quality incentive vouchers. The incentive vouchers may be submitted to a goods and service provider for payment to CRMC service providers such that the potential buyer and buyer of goods and service has an option to encourage and reward good quality of customer service management and caring (CRMC) services.

Another object of the present invention is to provide systems and methods to enable an online customer to log on a CRMC center that connects the customer to an CRMC service provider to carry out a virtual direct communication. The customer can make online arrangement with the CRMC service provider to carry out the CRMC program and to transfer vouchers to the CRMC service provider for the CRMC service provider to receive payment from the online GSP. The customer service management and care activities can be scheduled and arranged between the customer and CRMC service providers without requiring the customer to carry out a separate search to locate the local CRMC service providers for carrying out various CRMC tasks.

Briefly, in a preferred embodiment, the present invention discloses a network system includes an online goods and services provider (GSP) selling goods or services to an online customer through the network system. The online GSP further allows the customer to select a customer service management and caring (CRMC) program. The network system further includes an customer service management and caring (CRMC) center for issuing a set of CRMC vouchers defining an CRMC program related to the goods and services transmitted over the network to the online customer to store in the customer's computer. Each of the CRMC vouchers further provides a link for linking the customer through the network to the CRMC center. The CRMC center provides a list of CRMC service provider near the customer for the customer to choose a selected CRMC service provider. The CRMC center provides a virtual direct communication between the customer and the selected CRMC service provider for the customer to arrange with the CRMC service provider to perform the CRMC program and transfer a set of program-related CRMC vouchers over the network the CRMC service provider. The selected CRMC service provider then transfers the program-related CRMC vouchers to the online GSP provider for payment of the CRMC program performed for the online customer. The CRMC center then sends a reminder over the network to the online customer to request a set of incentive vouchers for the selected CRMC service providers for rewarding the selected CRMC service provider according to a level of customer-satisfaction. The customer then provides an input of the level of customer satisfaction and comments for the selected CRMC service provider and transfers the set of incentive vouchers to the CRMC center according to the level of customer satisfaction. The CRMC center then transfers the set of incentive CRMC voucher to the online GSP provider for making reward payment to the selected CRMC service provider. In a preferred embodiment, the CRMC center further carries an insurance to pay the selected CRMC service provider if the online GSP refuse or unable to make payment to the selected CRMC service provider after performing the CRMC program for the online customer.

In essence this invention discloses a method for transferring electronic vouchers over a network system for defining and rewarding a customer relationship management (CRM) service and customer care activity. In a preferred embodiment, the method further includes a step of transferring an incentive electronic voucher for payment according to an assessment of customer satisfaction.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is an network system includes an online customer relationship management and caring (CRMC) center issuing CRMC vouchers and manage CRMC resources and communications to enhance CRMC program execution and customer service and care;

FIGS. 2A and 2B is a flow chart showing the processing steps carried out by the all the parties involved in carrying out the customer relationship management and caring (CRMC) program;

FIG. 3 is a flow chart showing the processing steps carried out by all the parties in carrying out the CRMC programs to satisfy different customer requirements and needs;

FIG. 4 is a functional block diagram for illustrating a system configuration for server and associated database of an CRMC center provided to perform the CRMC program coordination and management.

### DETAILED DESCRIPTION OF THE PREFERRED EMBODIMENT

Reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment.

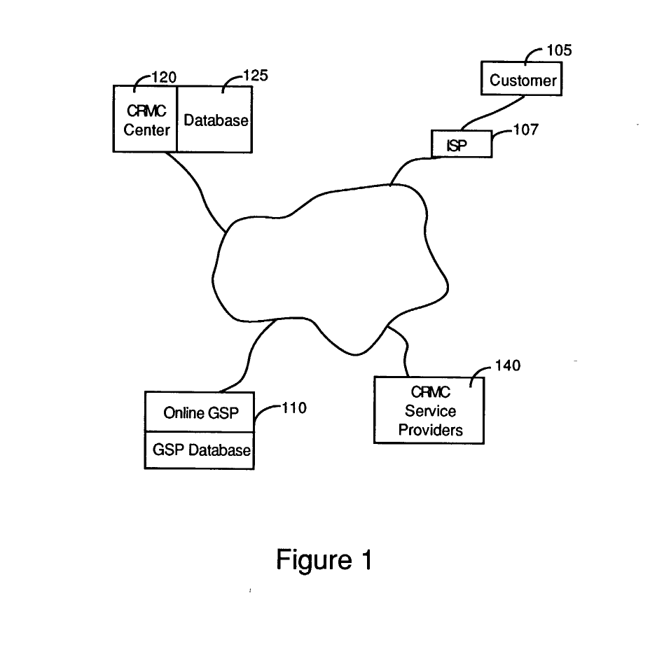

FIG. 1 is a functional block diagram of data communication network system 100, e.g., an Internet system or a wireless data transmission network. The network comprises an online customer 105 connected to the network communication system 100 with a personal computer (PC), or other network data-handling system, through an Internet service provider (ISP) 107. The ISP 107 receives a dial-up call from the customer 105 through a network interface device 106 and checks the user ID and password to allow the PC to log on to the ISP 106 and connected to the network system 100. The network system further includes an online goods and service provider (GSP) 110, preferably operating an online web-server with goods and service catalogs to allow the online customer to browse and carries out an online shopping. The network system further includes a customer relationship-management and care center (CRMC) center 120 for issuing a set of electronic CRMC vouchers over the network to the customer 105. The CRMC center 120 further includes a database 125 for storing information of many customer relationship-management and care (CRMC) service providers 140 for providing consultations and guidance to the customer 105 in making a decision for purchasing goods or services. Each of these CRMC service providers 140 is pre-registered with the CRMC center 120 by entering qualifications or experience to provide consultation or guidance to the customer 105 as potential buyer for making an intelligent decision for purchasing specific products or services from particular online GSP 110. The qualifications or experiences of these CRMC service providers can be categorized into different levels for receiving different kinds of vouchers that will be further discussed below.

The CRMC center 120 includes a database 125 for storing relevant data and information for a plurality of CRMC service providers 140. The CRMC center 120 guides the customer 105 to review information of these CRMC service providers 140. The customer 105 then selects a CRMC service provider and downloads a set of electronic CRMC vouchers each voucher related to goods or services of a particular online GSP for storing in the customer's computer. By clicking these vouchers, a customer 105 is linked to the CRMC center 120 and the CRMC center 120 establishes a virtual-direct network interactive-connection for the customer 105 to interactively communicate with the selected CRMC service provider by selecting a CRMC program. Examples of such CRMC program may rang from downloading a product or service quality review article related to particular goods or services. A more involved CRMC program may include telephone discussion with CRMC service provider for an evaluation and sharing of personal experience with the products, or even actual demonstrations and hands-on operation of the products for explaining and assessing various functions of the products. Different kinds of vouchers may be used for receiving these kinds of CMRC services. The CRMC center 120 provides a virtual-direct network interactive communication for the customer 105 with the selected CRMC service provider 140 to arrange time and place for carrying out the selected CRMC program and sending electronic vouchers to the CRMC service provider depending on the CRMC program selected.

After the customer 105 receives the CRMC services, with the information and consultation of particular products or services received from the selected CRMC service provider 140, the customer 105 may decide to purchase a particular products or services. The customer may then log on to the CRMC center 120 for sending a CRMC discount voucher to the online GSP. For cost accounting purpose, the CRMC discount voucher basically reflects the cost savings as a benefit received by the online GSP 110 because the requirements of staffing and management of an in-house CRMC service group are now reduced. The CRMC center 120 establishes a virtual-direct network interactive communication between the customer 105 and the online GSP 110 for the customer 105 to send the CRMC discount voucher and to complete the online transaction to purchase the products or services. At the completion of the online transaction, the CRMC center 120 sends an online commission voucher to the CRMC service provider 140. Then, the CRMC service provider 140 sends the CRMC vouchers received from the customer 105 and the commission voucher received from the CRMC center 120 to the online GSP 110 to receive a payments. The payments made to the CRMC service provider include the payment to the CRMC voucher for the services performed according to the CRMC program selected by the customer 105. The online GSP 110 further makes a payment to the CRMC service provider 140 for the commission voucher. The amount of the commission voucher may reflect the cost savings of the online GSP 110 because of the reduced amount of moneys spent in advertisement for promoting the products or services. The CRMC service providers 140 now takes care of the CRMC functions, and also, the CRMC service providers 140 act in part as salesmen for the online GSP 110 in introducing and guiding the customer 105 to purchase goods and services from the online GSP 110.

In addition to the CRMC vouchers and the commission voucher as described above, the customer and the online GSP may further reward the CRMC service provider 140 with quality-incentive vouchers according to customer or GSP satisfaction level for the quality of services provided by the CRMC service provider 140. The online GSP 110 may match customer's quality incentive voucher to significantly increase the incentive for a CRMC service provider to carry out the CRMC programs to gain higher levels of customer satisfaction. Comments and opinions for each CRMC service provider 140 are also entered by the customers 105 or the online GSP 105 and recorded in the database at the CRMC center 120 as future references for the customer 105 to select the CRMC service provider 140.

Instead of the conventional method that a online GSP, e.g., a seller or manufacturer, provides the centralized CRM web-sites or calling centers with limited-information channels, this invention discloses an open and distributed CRMC program to benefit the customer 105. The CRMC service providers are now given significant incentive to satisfy the needs of customers 105 by attending to customer's individual needs and requirements. This open and distributed CRMC program also benefits the online GSP 110 because the moneys paid to the CRMC service providers according to the types and amount of vouchers submitted are spent directly related to activities for customer relationship management and care. Cost savings are achieved with reduced personnel to staff the centralized in-house CRMC organizations, calling centers and technical support to handle questions or inquiries from the customers. Furthermore, the online GSP may also be benefited from reduced resources spent on advertisement for promoting goods and services because the CRMC service providers now act in part as direct marketing and sales-person for the online GSP 110. All these customer relationship management and care (CRMC) activities can be traced with a unique set of voucher numbers with these vouchers conveniently sent and stored electronically over the network. The database of the CRMC center now records all the results and comments or opinions of such services for further assessment of effectiveness and for reference by customer to select a CRMC service provider.

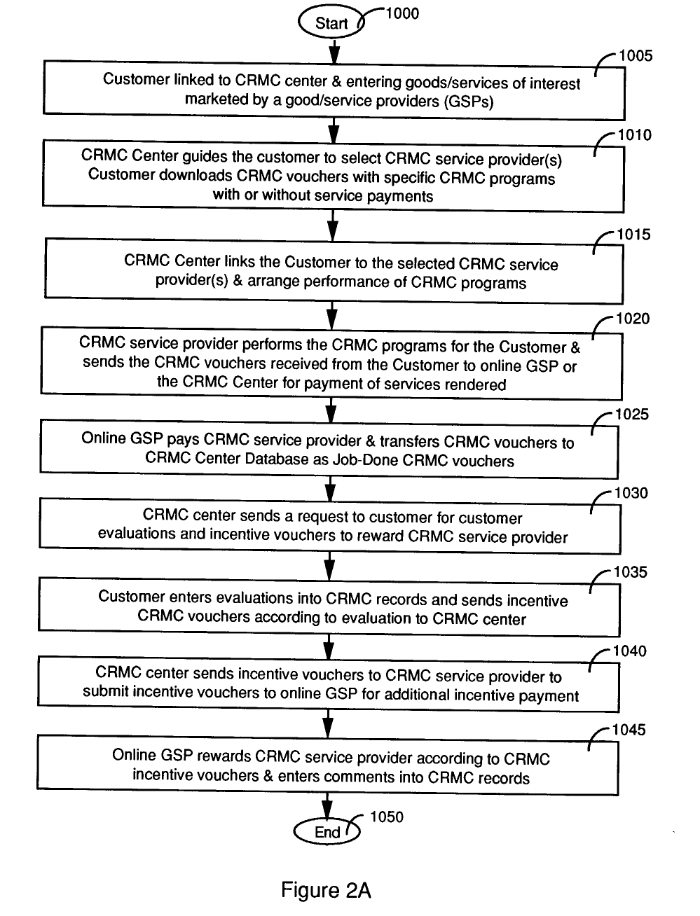

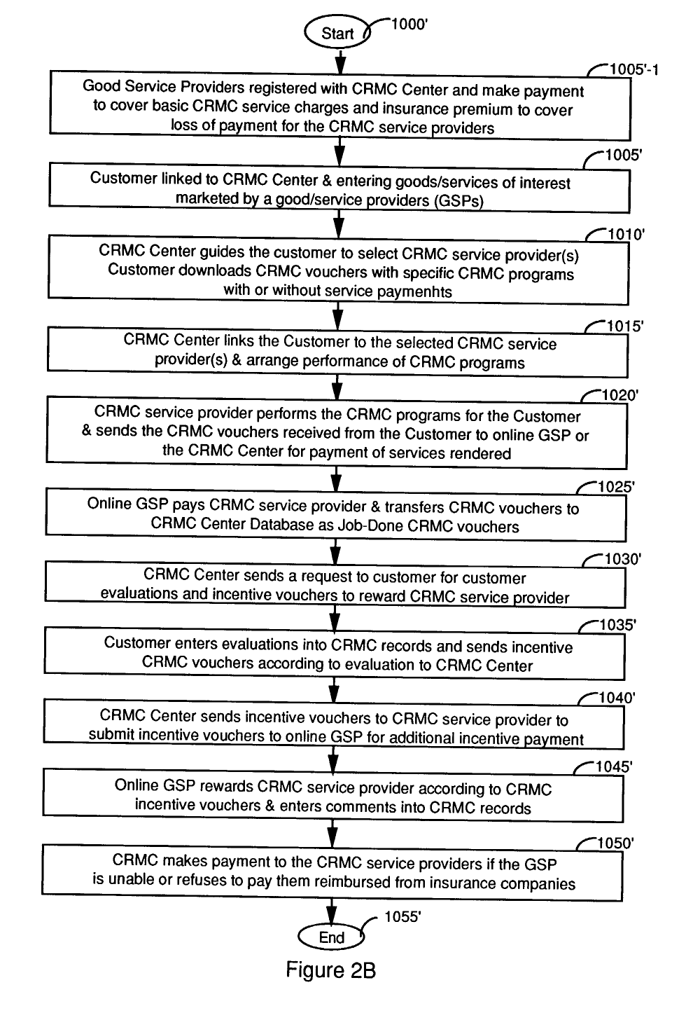

FIG. 2A is a flow chart for showing the interactive processing steps for an improved customer relationship management and care (CRMC) program implemented with electronic CRMC vouchers transferred over the network 100 disclosed in this application. These processing steps are carried out by online interactions between all parties involved to assure the CRMC activities are carried out properly. These parties include a customer 105, an online goods and services provider (GSP) 110, a customer relationship management and care (CRMC) center 120, and the customer relationship management and care (CRMC) service providers 140 to complete the tasks of customer relationship management and care programs.

The process begins (step 1000) with a customer 105, as a potential buyer of particular goods or services, logs on a customer relationship management and care (CRMC) center 120 to review different kinds of CRMC programs available to assist the customer 105. The customer 105 enters the goods or services of interest and in need of assistance for making intelligent decisions of buying, leasing, subscribing or signing on as a member (step 1005). As the life of modern society becomes more complex, each of these decisions often requires consultation from experts. The CRMC center 120 then guides the customer 105 to review the database listed with different CRMC service providers that could assist the customer in formulating an opinion to reach a decision for particular goods or services. The customer 105 then reviews the records of these CRMC service providers 140 and selects one or several of these CRMC service providers 140 for carrying out a CRMC program. The customer then downloads CRMC vouchers with specific CRMC programs with or without making payments for such services depending on the programs selected (step 1010). The CRMC center 120 then establishes a virtual direct network interactive communication between the customer and each one of these selected CRMC service providers for selecting a CRMC program and for downloading the CRMC vouchers for the selected CRMC program (step 1015). The customer 105 makes an arrangement over the network, e.g., Internet, with the CRMC service provider 140 to arrange for time and place and all other details for performing the selected CRMC programs. The CRMC service provider 140 then carries out the CRMC programs selected by the customer 105 by providing assistance to the customer (step 1020). These CRMC programs may include sending review articles for the goods and services, answering customer's questions, demonstrating the operations of product, or making on-site presentations to explain the benefits of using the products or services.

After the CRMC service provider 140 complete customer selected CRMC programs, the customer pays the CRMC service provider by transferring the CRMC vouchers to the online GSP as a request for the payment from the online GSP for performing the CRMC programs according to the vouchers (step 1025). As the online GSP receives the vouchers, a payment is made to the CRMC service provider 140. Meanwhile, a click on one of these vouchers establishes a link to the CRMC center 120 (step 1045) for transferring the vouchers to the database 120-DB of the CRMC center 120 as a “job-done CRMC vouchers” stored into the database as a CRMC record. (Step 1025) With these CRMC job-done CRMC vouchers, the CRMC center 120 then sends a request to the customer 105 for customer's evaluation for the service quality of the CRMC service provider 140 in carrying out the CRMC tasks (1030). The customer 105 is also asked to submit a reward voucher if the customer 105 considers that the CRMC service provider 140 deserve a reward when the CRMC processes are carried out with high quality. The customer 105 can also review the descriptions of the CRMC tasks performed by the CRMC service provider 140 and enters customer's comments regarding these CRMC records entered by the CRMC service provider 140 (step 1035). The online GSP 110 may also reward the CRMC service provider 140 with incentive vouchers if the CRMC service provider 140 provide a high quality service to the customer 105 (step 1035). These records are entered into the database of the CRMC center 120-DB and available for review by the online GSP 110, the CRMC service provider 140, the customer 105. These records are also made available for another customer to review and use as a reference in selecting a CRMC service provider to carry out the CRMC processes (step 1005). The CRMC center 120 then sends the reward voucher to the CRMC service provider 140 for submitting the incentive vouchers to the online GSP for payment (step 1040). The online GSP 110 for the online GSP to make reward payment to the CRMC service provider 140 for rewarding a job well done (step 1045) to end the CRMC program (step 1050).

The amounts of payment for different kinds of vouchers to the CRMC service providers 140 may be structured to provide significant incentive for the CRMC service provider 140 to carefully and diligently carry out the CRMC tasks. The customer 105 is enabled to have more control by rewarding the CRMC service provider 140 for a job well done or to withhold the reward when the customer 105 is not satisfied with quality of the consultation and customer care provided by the selected CRMC service provider 140. In the meantime, the vouchers along with the service records and comments stored in the database of the CRMC center 120 serve the function for tracking and maintaining a record of all the customer relationship management and care (CRMC) activities. The online GSP now receives the benefits that the process and cost structures of the CRMC operations are well defined and the customers are taken care of with clearly defined procedures. The database used to store data and information for all customer relationship management and care activities further provide valuable information for improvement of product and service. The information may also be useful for early detection and correction of design errors or product defects when large number of negative comments generated from CRMC activities for particular products or services. The customer 105 is served with clearly defined CRMC procedures without having to make repeated calls to the sellers not knowing how and when to receive reliable and creditable consultations. The vouchers, each with a unique alphanumeric designation is now used as a customer relationship management and care identification (CRMC-ID) to keep track and to provide clear status of the developments of each step of the CRMC processes. Also, the customer 105 has the flexibility to select a local CRMC service provider such that a visit and face-to face meeting can be easily arranged to assure each of the CRMC tasks are performed timely and according to standards specified in the vouchers.

To further assure that a customer's and the CRMC service provider's interests are properly protected, the CRMC center 120 may carry a CRMC insurance. The CRMC insurance is to compensate the financial losses of a CRMC service provider when the online GSP refuse to pay the CRMC service providers for the CRMC and reward vouchers. At the time when a GSP registers with the CRMC center, a small amount of insurance premium and a reserve fund for basic CRMC program payment may be required from each online GSP. (step 1005-1 of FIG. 2B) With an insurance coverage, the CRMC service providers are protected that payment for the customer relationship management and care programs as promised by the online GSP will be properly compensated in case the online GSP refuses or cannot fulfill the promises. Again, with the vouchers for tracking the CRMC activities and service records now stored in the CRMC database 120-DB, an insurance claim can be definitely and specifically documented. With such insurance program, the CRMC service providers can be assured that a payment will be paid for performing the CRMC programs and the potential rewards will be also paid even if the online GSP would not or cannot pay in the future. The electronic commerce will be enhanced when the interests of the parties involved are all properly protected. For the purpose of assuring that each CRMC service provider is qualified to perform different kinds of CRMC services, a certificate program may be setup to certify the level of skill and knowledge levels of each CRMC service provider according to the industrial standards for different products and services. The certified CRMC service providers are registered with the CRMC center with proper documents to show the qualifications to carry out different CRMC programs according to the certified training and skill levels based on the industrial standard certifications for each CRMC service provider. Depending on the nature of the CRMC programs defined by the CRMC vouchers, the certification may also be issued to an organization or business entity that is constituted with a group of people certified under the industrial standards.

The customer relationship management and care program can also be carried out without requiring the use of Internet. All or part of the required communications, and transmissions of vouchers and information can be carried out by telephone calls or mail or in combination with operations on Internet. For instance, a potential buyer can obtain different kinds of vouchers in a store or as a tear-out coupon attached to a magazine. With the information provided on the vouchers, the potential customers may access the CRMC center on Internet through a library computer available to the public to find out information about CRMC service providers in the local areas. Or the yellow page of magazines would provide information about particular CRMC service provides. Different CRMC programs are arranged through communication over the telephone. After the CRMC programs are performed, the customers then submitted the CRMC vouchers that may include the regular and quality incentive vouchers to the CRMC service providers. The CRMC service providers then mail the vouchers to the CRMC center to process and submit to the good and service providers (GSP) either through Internet or regular mail systems. Payments to the CRMC service providers and information and comments about the quality of the service for particular CRMC service provider are transmitted through mail or Internet. The basic concept is to distribute the workload of the customer relationship management and care through an open voucher system for CRMC service providers to perform individual and personal services. Meanwhile, the voucher system allows the customers to control the reward to the CRMC service providers such that real and individual needs of the customers can be satisfied. In the meantime, the effectiveness and cost of customer relationship management and care can be clearly tracked with quantifiable amount directly related to real CRMC activities with reduced in-house employees to maintain the customer relationship management department.

### EXAMPLE

### Customer Interested in Buying a Personal Digital Assistance (PDA)

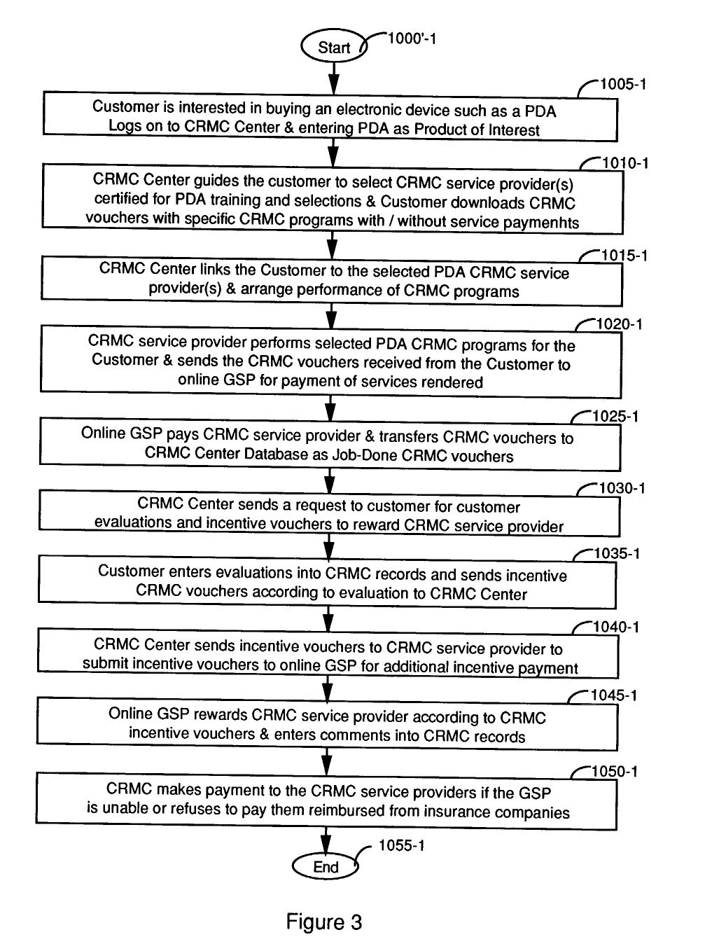

Referring to FIG. 3 for steps carried out for assisting a potential customer to search and buy a personal digital assistant (PDA) according to a customer's special needs and budget. As the customer 105 is interested to buy a personal digital assistance (PDA) device (step 1001), the user first obtains the information for different CRMC service providers. A list of local CRMC service providers is provided in the CRMC Web site on the Internet system (step 1005-1). A perspective customer can also obtain a list of local CRMC service providers from an advertisement in a local newspaper, a magazine tear-out, a store that sells PDAs, or a consumer report available in the reference book section of a local library. In the meantime, a perspective PDA buyer may either download a set of CRMC vouchers from the Web-site of the CRMC center or get a set of vouchers from a local store or by mail through calling the CRMC center. The CRMC vouchers define types and general scopes of CRMC services to be performed by a CRMC service provider. The CRMC services may involve an initial consultation for comparing different features available for different kinds of PDAs and assisting a perspective PDA purchaser to decide a best model to buy depending on user's special needs, preferences and budget. Another type of CRMC program may involve actual demonstrations and executing of several application programs on a special PDA to assist a perspective buyer to actually experience the operations and functions of a PDA before a decision is made whether to purchase a particular model of PDA. The CRMC center guides the customer to select the CRMC service provider. The customer then downloads a set of CRMC vouchers that define specific CRMC programs with or without making payment for the CRMC programs depending on the CRMC programs selected. (Step 1010-1) The CRMC center then links the customer to the selected PDA service providers to arrange a time and location for carrying out the CRMC programs according to the vouchers (Step 1015-1). The CRMC service providers, e.g., a service providers certified for performing the service for particular PDAs, then carries out the services. The customer then sends the CRMC vouchers to the CRMC service providers for transmitting the vouchers to the CRMC center or the GSP to request for a payment of service provided. (Step 1020-1)

The GSP when making payment to the CRMC service provider also sends the CRMC vouchers to the CRMC center to enter into the database as the job-done vouchers. (step 1025-1). The CRMC center sends a request to the customer to request customer's evaluation of the CRMC service provider's service (step 1030-1). The CRMC center also requests the customer to provide incentive vouchers to reward the CRMC service provider for services provided that are evaluated as exceeding customer's expectation of service. Depending on customer's evaluation, different levels of incentive vouchers may be provided by the customer to reward the CRMC service provider (step 1035-1). The CRMC center sends the incentive vouchers to the CRMC service providers for submitting to the GSP to request for additional incentive payment to reward a high customer satisfaction performance (step 1040-1). The online GSP makes payment to the CRMC service providers according to the incentive vouchers and also enters the information of the CRMC service provider into the CRMC database. Under the situation when the online GSP is unwilling or unable to make payment to the CRMC service providers, the CRMC center makes payment according to the CRMC vouchers based on the services performed by the CRMC service providers and the incentive vouchers for high quality service according to the satisfaction levels of the customer. The CRMC center then obtains reimbursement from the insurance companies according to the insurance policies (step 1050-1) then the process for the PDA CRMC program ends (step 1055-1).

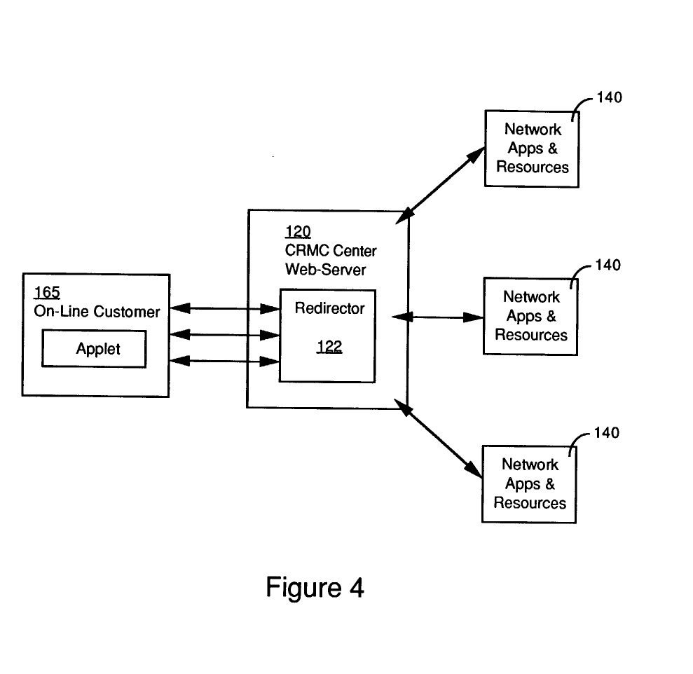

FIG. 4 show a functional block diagram for illustrating a virtual direct network communication between an online customer 105 and an CRMC service provider 140. The CRMC center 120 is implemented as a web server 120 and the online customer 105 is now communicating to the CRMC center through an Applet. The Applet is now received by a network communication redirecting means 122. The Applet is then redirected to one of the several CRMC service providers 140 represent as a network application-and-resources. The network communication redirecting means can be a stream-socket connection processor implemented in the web server for the CRMC center 120. With the network communication redirecting means 122, implementing the stream-socket connection processor, the CRMC center 120 can generate a virtual direct communication between the customer 105 and one of the CRMC service providers 140. The technical details can be further referenced to the U.S. Pat. No. 5,987,523 and that patent is hereby incorporated by reference. Even that the virtual direct communication is provided by the CRMC center in each of above examples, the invention disclosed by the Patent Application can be implemented without the use of this network communication technique. However, it is recognized that the virtual direct communication provided by the CRMC center web server greatly enhance the convenience and flexibility of the customer 105 to transfer ofCRMC vouchers and arrange CRMC programs defined by the CRMC vouchers. Also, the CRMC vouchers can also be issued and managed by the online GSP directly without the CRMC center as described above. But again, the CRMC center provides a valuable service with data records and public access to objectively and effectively coordinates and manages the after-sales service and customer care program whereby the consumer benefits are better protected.

Based on FIGS. 1 to 4 and above descriptions, this invention discloses a network system connected with an online goods and services provider (GSP) 110 selling goods-or-services to an online customer 105 through the network system. The network system further includes a customer relationship management and care (CRMC) center 120 for issuing an electronic CRMC voucher defining an CRMC program related to sales of the goods-or-services wherein the electronic CRMC vouchers are provided for transmitting over the network. In a preferred embodiment, the network system further includes a customer relationship management and care (CRMC) 140 provider connected to the network for receiving the electronic service voucher transmitted over the network for carrying out the CRMC program for the customer. In a preferred embodiment, the customer relationship management and care (CRMC) center is further provided to issue an incentive voucher for enabling the customer to reward the CRMC service provider according to a customer satisfaction assessment by the customer. In another preferred embodiment, the customer relationship management and care (CRMC) center further includes a virtual-direct network communicating means 122 for enabling a virtual-direct network communication between the online customer and the CRMC service provider to arrange for the CRMC program and for transmitting the CRMC voucher over the network. In another preferred embodiment, the virtual-direct network-communication means 120 further comprises a stream-socket means. The stream socket means is for providing stream-sockets for connecting network messages transmitted between the online customer and the CRMC center and between the CRMC service provider and the CRMC center to establish a stream-socket connected direct communication between the online customer and CRMC service provider. In another preferred embodiment, the network system is a wireless network system. The network system further includes a customer relationship management and care (CRMC) center further includes an CRMC database for keeping a record related to the CRMC program. The CRMC database further includes database manager for organizing the record kept in the CRMC database according to the online GSP, the online customer and the CRMC service provider.

This invention further discloses a method of selling goods-or-service by an online goods and services provider (GSP) to an online customer through a network system. The method includes steps of a) the online GSP issuing an electronic CRMC voucher for defining an CRMC program related to sales of the goods-or-services and for transmitting the electronic CRMC vouchers over the network. In another preferred embodiment, the method further includes a step of connecting a customer relationship management and care (CRMC) provider to the network for receiving the electronic service voucher transmitted over the network for carrying out the CRMC program for the customer. In another preferred embodiment, the the step of issuing the electronic CRMC voucher further comprises a step of issuing an incentive voucher for enabling the customer to reward the CRMC service provider according to a customer satisfaction assessment by the customer. In another preferred embodiment, the method further includes a step of providing to the online GSP a virtual-direct network communicating means for enabling a virtual-direct network communication between the online customer and the CRMC service provider to arrange for the CRMC program and for transmitting the CRMC voucher over the network.

In summary, this invention discloses a method for carrying out an online electronic commerce. The method includes a step of transmitting an electronic voucher over a network system for defining and rewarding an after-sales service and customer care (CRMC) activity related to the electronic commerce. In another preferred embodiment, the method further includes a step of transmitting an electronic CRMC incentive voucher for rewarding an CRMC service provider performing the CRMC activity according a customer assessment of an CRMC satisfaction level.

In essence, this invention disclosed a deliverable means for defining a service performance by a service provider wherein the deliverable means further includes a customer satisfaction indicator for specifying a value amount payable to reward the service provider for the service performance according to the customer satisfaction indicator. In a preferred embodiment, the deliverable means is an electronic voucher deliverable over a computer network. In another preferred embodiment, the deliverable means is a paper voucher includes printed information thereon. In another preferred embodiment, the deliverable means further provides a certification requirement for the service provider to carry out the service performance defined by the deliverable means. In another preferred embodiment, the deliverable means further specifies a good and service provider (GSP) promises to honor the deliverable means. In another preferred embodiment, this invention disclosed a deliverable means that is deliverable to a customer for specifying a customer relationship management and care (CRMC) service performance provided to be performed by a service provider for a customer.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1 A network system connected with an online goods and services provider (GSP) selling goods-or-services to a perspective customer through the network system, the network system further comprising
a customer relationship management and care (CRMC) center for issuing an electronic CRMC voucher transmitting over said network for defining an CRMC program to aid said perspective customer to make decision of purchasing and using said goods-or-services provided by said online GSP.

2. The network system of claim 1 further comprising:
a customer relationship management and care (CRMC) provider connected to said network for receiving said electronic CRMC voucher transmitted over said network for carrying out said CRMC program for said perspective customer.

3. The network system of claim 2 wherein:
said customer relationship management and care (CRMC) center is further provided to issue an incentive CRMC voucher for enabling said perspective customer to reward said CRMC service provider according to a customer satisfaction assessment by said perspective customer.

4. The network system of claim 2 wherein:
said customer relationship management and care (CRMC) center further includes a virtual-direct network communicating means for enabling a virtual-direct network communication between said perspective customer and said CRMC service provider to arrange for said CRMC program and for transmitting said CRMC voucher over said network.

5. The network system of claim 4 wherein:
said virtual-direct network-communication means further comprises a stream-socket means for providing stream-sockets for connecting network messages transmitted between said perspective customer and said CRMC center and between said CRMC service provider and said CRMC center to establish a stream-socket connected direct communication between said perspective customer and CRMC service provider.

6. The network system of claim 2 wherein:
said customer relationship management and care (CRMC) center further includes an CRMC database for keeping a record related to said CRMC program.

7. The network system of claim 2 wherein:
said CRMC database further includes database manager for organizing said record kept in said CRMC database according to said online GSP, said perspective customer and said CRMC service provider.

8 A network system connected with an online goods and services provider (GSP) selling goods-or-services available for purchase by a perspective customer, wherein:
said online GSP further includes an electronic CRMC voucher issuing means for issuing an CRMC voucher transmitting over said network for defining an CRMC program to aid said perspective customer to make decision of purchasing and using said goods-or-services.

9. The network system of claim 8 further comprising:
a customer relationship management and care (CRMC) provider connected to said network for receiving said electronic CRMC voucher transmitted over said network for carrying out said CRMC program to aid said perspective customer to make decision of purchasing and using said goods-or-services.

10. The network system of claim 9 wherein:
said electronic voucher issuing means further provided to issue an incentive voucher for enabling said perspective customer to reward said CRMC service provider according to a customer satisfaction assessment by said perspective customer.

11. The network system of claim 9 wherein:
said online GSP further includes a virtual-direct network communicating means for enabling a virtual-direct network communication between said perspective customer and said CRMC service provider to arrange for said CRMC program and for transmitting said CRMC voucher over said network.

12. The network system of claim 11 wherein:
said virtual-direct network-communication means further comprises a stream-socket means for providing stream-sockets for connecting network messages transmitted between said perspective customer and said CRMC center and between said CRMC service provider and said CRMC center to establish a stream-socket connected direct communication between said perspective customer and CRMC service provider.

13. The network system of claim 9 wherein:
said electronic CRMC voucher issuing means further includes an CRMC database for keeping a record related to said CRMC program.

14. The network system of claim 9 wherein:
said CRMC database further includes database manager for organizing said record kept in said CRMC database according to said perspective customer and said CRMC service provider.

15 A network system connected with an online goods and services provider (GSP) selling goods-or-services on said network wherein said network system further comprising
an electronic customer relationship management and care (CRMC) voucher transmitted over said network having an unique CRMC voucher identifier for defining and tracking a customer relationship management and care (CRMC) program provided to aid a perspective customer to make decision of purchasing and using said goods-or-services.

16 The network system of claim 15 further comprising
said perspective customer further having a network connection means for receiving said electronic CRMC voucher from said network for activating said CRMC program.

17 The network system of claim 15 further comprising
a customer relationship management and care (CRMC) provider to receive said electronic CRMC voucher transmitted over said network for performing said CRMC program defined and tracked by said electronic CRMC voucher.

18 The network system of claim 15 further comprising
a customer relationship management and care (CRMC) center for issuing said electronic CRMC voucher and for coordinating and tracking said CRMC program.

19. The network system of claim 18 wherein:
said CRMC center further includes an CRMC database for recording data related to said CRMC program.

20. The network system of claim 18 further comprising:
said perspective customer further having a network connecting means for receiving said electronic CRMC voucher from said CRMC center for activating said CRMC program;
a customer relationship management and care (CRMC) provider;
said CRMC center further includes a virtual-direct network communication means for enabling a virtual-direct network communication between said perspective customer and said CRMC service provider for transmitting said CRMC voucher over said network to said CRMC service provider to make arrangement for carrying out said CRMC program defined and tracked by said CRMC voucher.

21. The network system of claim 15 wherein:
a customer relationship management and care (CRMC) center for issuing said electronic CRMC voucher and for coordinating, tracking and carrying an insurance policy for said CRMC program.

22. A network system connected with an online goods and services provider (GSP) selling goods-or-services to a perspective customer through the network system, the network system further comprising:
a customer relationship management and care (CRMC) center for issuing an electronic CRMC voucher transmitted over said network for defining a customer relationship management and care (CRMC) program provided to aid a perspective customer to make decision of purchasing and using said goods-or-services;
a plurality of customer relationship management and care (CRMC) providers connected to said network;
said CRMC center having an CRMC database for storing a record for each of said CRMC service providers for allowing said perspective customer to review and to chose a selected CRMC service provider;
said CRMC center further includes a virtual-direct network communicating means for enabling a virtual-direct network communication between said perspective customer and said selected CRMC service provider to arrange for said CRMC program and for said perspective customer to transmit said CRMC voucher to said selected CRMC service provider over said network; and
said customer relationship management and care (CRMC) center is further provided to issue an incentive voucher for enabling said perspective customer to reward said selected CRMC service provider according to a customer satisfaction assessment by said customer.

23. The network system of claim 1 wherein:
said network system is a wireless system.

24. The network system of claim 8 wherein:
said network system is a wireless system.

25. The network system of claim 15 wherein:
said network system is a wireless system.

26. The network system of claim 22 wherein:
said network system is a wireless system.

27. A method of selling goods-or-service by an online goods and services provider (GSP) to a perspective customer through a network system comprising
connecting a customer relationship management and care (CRMC) center to said network for issuing an electronic CRMC voucher transmitted over said network for defining a CRMC program to aid said perspective customer to make decision of purchasing and using said goods-or-services.

28. The method of claim 27 further comprising a step of:
connecting a customer relationship management and care (CRMC) provider to said network for receiving said electronic CRMC voucher transmitted over said network for carrying out said CRMC program for said perspective customer.

29. The method of claim 28 further comprising a step of:
issuing an incentive voucher for enabling said perspective customer to reward said CRMC service provider according to a customer satisfaction assessment by said perspective customer.

30. The method of claim 28 wherein:
providing to said customer relationship management and care (CRMC) center a virtual-direct network communicating means for enabling a virtual-direct network communication between said perspective customer and said CRMC service provider to arrange for said CRMC program and for transmitting said CRMC voucher from said perspective customer over said network to said CRMC service provider.

31. The method of claim 30 wherein:
said step of providing to said virtual-direct network-communication means further includes steps of providing a stream-socket means for providing stream-sockets for connecting network messages transmitted between said perspective customer and said CRMC center and between said CRMC service provider and said CRMC center to establish a stream-socket connected direct communication between said perspective customer and CRMC service provider.

32. The method of claim 28 further comprising a step of:
keeping a record related to said CRMC program in an CRMC database.
